(19) United States
(12) Patent Application Publication
(10) Pub. No.: US 2021/0365851 A1
(43) Pub. Date: Nov. 25, 2021

(54) PRODUCTION PLAN SCHEDULE CREATION METHOD AND INFORMATION PROCESSING DEVICE

(71) Applicant: Hitachi, Ltd., Chiyoda-ku, Tokyo (JP)

(72) Inventors: Yoshihiro WAKISAKA, Tokyo (JP); Teruo NAKATA, Tokyo (JP)

(73) Assignee: Hitachi, Ltd., Chiyoda-ku, Tokyo (JP)

(21) Appl. No.: 16/980,509

(22) PCT Filed: Feb. 21, 2019
(86) PCT No.: PCT/JP2019/006492

§ 371 Date: Sep. 14, 2020

(30) Foreign Application Priority Data
Jun. 6, 2018 (JP) 2018-108306

(51) Int. Cl. G06Q 10/06; G05B 19/418

(52) U.S. Cl. CPC G06Q 10/0631; G05B 2219/32088; G05B 19/41865

(57) ABSTRACT

The present invention makes it possible to automatically define a work time for creating a model even if a work time distribution in work record data is not uniform. For this purpose, features of work time distributions are extracted for individual product type numbers and individual work codes on the basis of a feature classification library 202 from work record data 201 indicating the times taken for work associated with prescribed work codes for products associated with prescribed product type numbers (101), and if the extracted features of a per-product-type-number and per-work-code work time distribution have distribution features defined in a work-time definition library 203, work-time definition data defining a per-product-type-number and per-work-code work time is created according to an algorithm defined in the work-time definition library in accordance with the distribution features (102).

### TECHNICAL FIELD

The present invention relates to a production plan schedule creation method and an information processing device that make a production plan schedule using work performance information at a work site.

### BACKGROUND ART

As a system that defines a processing time based on log information of a production device, for example, PTL 1 discloses a production index information generating device, a program, and a method of generating production information that generate a group of processing targets whose end time is at a predetermined interval, classify the generated group according to the number of the processing targets included in the group, and specify the processing time for each classification.

### CITATION LIST

### Patent Literature

PTL 1: JP-A-2011-18263

### SUMMARY OF INVENTION

### Technical Problem

In the technique described in PTL 1, a work time cannot be specified for work characterized by a characteristic other than the number of the processing targets.

When a production model for creating a production plan schedule is constructed, it is necessary to define a work time for each work code. However, since the work code is not allocated for a purpose of creating the production model, performance data thereof is not uniform even for the same work code such that a work time distribution thereof is wide or includes a plurality of peaks, and the work time cannot be easily defined. When an appropriate work time is manually defined for each work code based on a characteristic of each work time distribution, the definition becomes personal and cannot be automated, and a man-hour required for modeling becomes large. An object of the invention is to automatically define a work time for modeling for work performance data having a non-uniform data distribution.

### Solution to Problem

A production plan schedule creation method for making a production schedule for producing products related to a plurality product model numbers by performing work related to a plurality of work codes for each product, which is an embodiment of the invention, includes: extracting, from work performance data required for work related to a predetermined work code for a product related to a predetermined product model number, a characteristic of a work time distribution for each product model number and for each work code based on a characteristic classification library; when the extracted characteristic of the work time distribution for each product model number and for each work code includes a distribution characteristic defined in a work time definition library, creating work time definition data that defines a work time for each product model number and for each work code in accordance with an algorithm defined in the work time definition library according to the distribution characteristic; constructing a production model for producing the products related to the plurality of product model numbers using the work time definition data; and optimizing the production model to minimize a lead time of the production model.

### Advantageous Effect

A work time for modeling for work performance data having a non-uniform data distribution can be automatically defined.

Other technical problems and novel characteristics will become apparent from a description of the description and the accompanying drawings.

### BRIEF DESCRIPTION OF DRAWINGS

FIG. 1 is a production plan schedule creation flow.

FIG. 2 is an example of a characteristic classification library.

FIG. 3 is an example of a work time definition library.

FIG. 4 is a hardware configuration example of an information processing device.

FIG. 5 is a time chart showing examples of production plan scheduling.

FIG. 6A is an example of work performance data.

FIG. 6B is a work time distribution (histogram) of the work performance data.

FIG. 6C is an example of a BOM diagram showing a component configuration of a product 1.

FIG. 7 is an example of a work time distribution (histogram) created by classifying the work performance data according to the number of components.

FIG. 8 is an example of work performance data obtained by adding a component number column.

FIG. 9 is a time chart when different work times are defined for each number of components.

FIG. 10 is an example of a histogram obtained by decomposing a time distribution of the work performance data into two distributions.

FIG. 11 is a time chart in which a work time is decomposed into a wait time and a net work time.

### DESCRIPTION OF EMBODIMENTS

An embodiment of the invention will be described in detail with reference to the drawings. However, the invention should not be construed as being limited to description of the embodiment described below. Those skilled in the art could have easily understood that specific configurations can be changed without departing from the spirit or gist of the invention.

In the configurations of the invention to be described below, the same part or a part having similar functions are denoted by same reference numerals in common among the different drawings, and a repetitive description thereof may be omitted.

In the present specification, expressions such as “first”, “second”, and “third” are used to identify components, and do not necessarily limit the number or order. Further, numbers for identification of the components may be used for each context, and the numbers used in one context may not necessarily indicate the same configuration in other contexts. Further, the components identified by a certain number do not interfere with the function of the components identified by other numbers.

In order to facilitate understanding of the invention, a position, a size, a shape, a range, or the like of each configuration shown in the drawings may not represent an actual position, size, shape, range, or the like. Therefore, the invention is not necessarily limited to the position, the size, the shape, the range, or the like disclosed in the drawings.

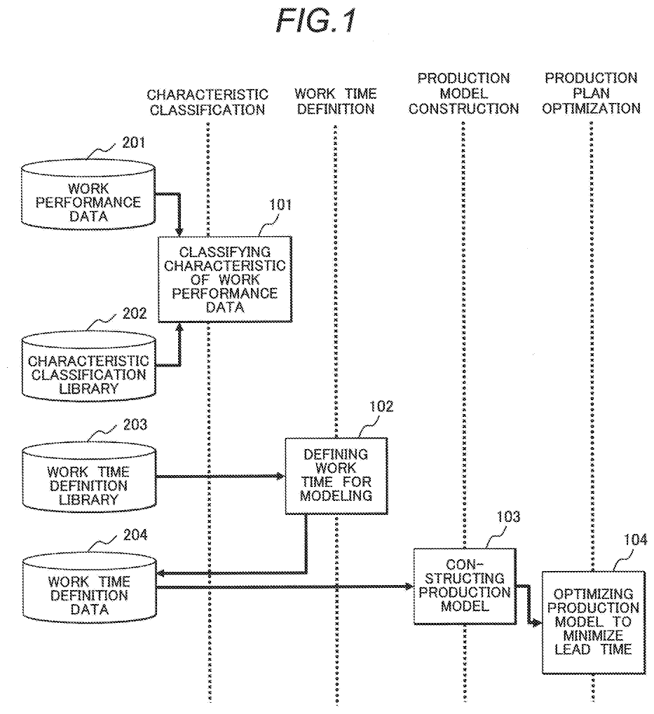

FIG. 1 shows a production plan schedule creation flow of the present embodiment. Work performance data 201 is performance data of a work time in each production process measured for each work code. The work performance data 201 may be data automatically acquired by a production system or data manually input by a person. In the present embodiment, by defining a work time related to a predetermined product model number and a predetermined work code according to a characteristic of a work time distribution thereof, it is possible to create a production plan schedule with high accuracy. More specifically, by defining in advance an arithmetic expression (algorithm) that defines the work time corresponding to the characteristic of the work time distribution, and by referring to the above-described definition and the characteristic of the work time distribution obtained from the work performance data 201, the definition of the work time is determined. The characteristic of the work time distribution and a program for extracting the characteristic are stored in a characteristic classification library 202. First, in a characteristic classification step 101, for a product for which the production plan schedule is to be set, work performance data related to a work code included in a process is extracted for each product model number from the work performance data 201, the work time distribution related to each work code is obtained, and the characteristic of the work time distribution is grasped for each work code.

The arithmetic expression (algorithm) of the work time applied to each characteristic of the work time distribution is stored in a work time definition library 203. In a work time definition step 102, work time definition data 204 for modeling is created for each work code by applying the arithmetic expression according to the characteristic of the work time distribution with reference to the work time definition library 203. Therefore, in the production plan schedule creation, a more realistic work time can be defined.

Then, in a production model construction step 103, a production model is constructed using the work time definition data 204 for modeling. In a production plan optimization unit 104, the production model is optimized so as to minimize a lead time while taking into account a constraint condition and the like for the constructed production model. By the series of processing, for example, a production plan in which the work time in a factory is optimized can be made based on the work performance data. Known methods can be applied to the production model construction step 103 and the production plan optimization unit 104, and the following description will focus on the characteristic classification step 101 and the work time definition step 102.

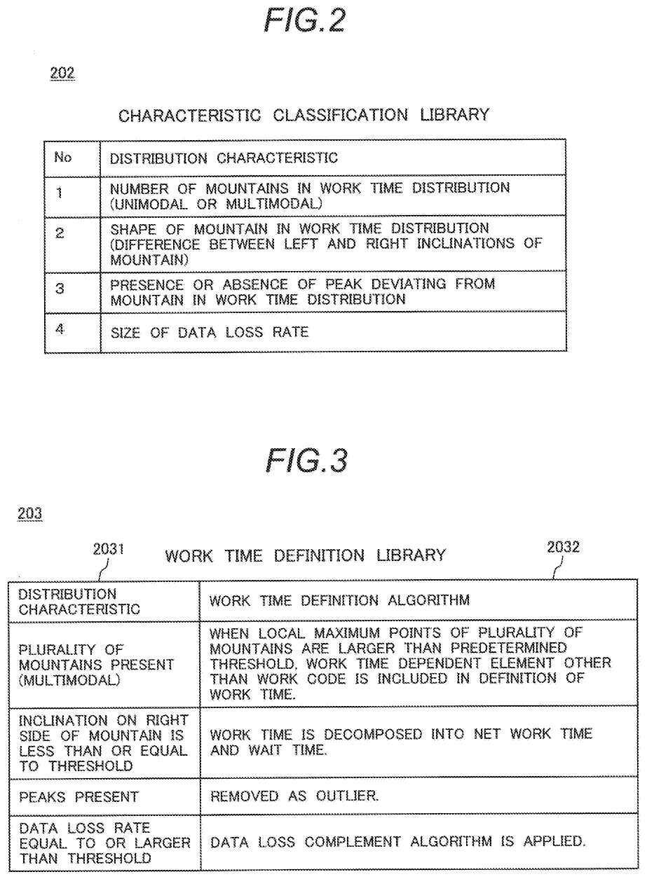

FIG. 2 shows an example of the characteristic classification library 202. Each distribution characteristic is a characteristic of the work time distribution. A distribution characteristic 1 is the number of mountains in the work time distribution. The distribution is described as unimodal when including only one mountain, and is described as multimodal when including a plurality of mountains. When the same work is repeatedly performed, variation occurs in the work time due to various factors, and the work time distribution is considered to form a normal distribution. Herein, a distribution that can be regarded as the normal distribution is called the mountain. Therefore, the multimodal distribution means that a plurality of normal distributions having different average work times are included in the work performance data related to the same work code. A distribution characteristic 2 indicates a shape of the mountain of the work time distribution, and indicates a deviation from the normal distribution. Since the normal distribution is a bilaterally symmetric distribution, it can be said that the larger a difference between left and right inclinations of the mountain is, the larger a deviation from the normal distribution is. A distribution characteristic 3 is a presence of a peak. Herein, the peak is different from the mountain in that the peak is a distribution having no base such as the normal distribution. A distribution characteristic 4 is a size of a data loss rate, and indicates an amount of data loss in the work performance data. These distribution characteristics are examples and other distribution characteristics other than those shown in FIG. 2 may be defined.

The characteristic classification library 202 includes a program for determining whether the work time distribution (histogram) includes the respective distribution characteristics. For example, a determination program of the distribution characteristic 1 searches for local maximum points having a frequency equal to or larger than a predetermined threshold in the work time distribution, determines that the distribution is a mountain when the distribution includes abase equal to or larger than a certain amount among the local maximum points, and counts the number of the mountains. A determination program of the distribution characteristic 2 extracts, among the distributions determined to be the mountains, those whose left and right gradients are significantly different. A determination program of the distribution characteristic 3 determines that the distribution is a peak when a base as the normal distribution cannot be extracted from the extracted local maximum points equal to or larger than the predetermined threshold. A determination program of the distribution characteristic 4 counts the number of pieces of data which are not recorded in the work performance data, and calculates the data loss rate. The programs may be stored in the characteristic classification library 202 as independent programs, or may be configured such that a common program for a common routine (for example, extraction of the local maximum point, determination of the mountain) is called from each determination program.

FIG. 3 shows an example of the work time definition library 203. The work time definition library 203 includes a work time definition algorithm applied to the work time distribution including a predetermined distribution characteristic among the distribution characteristics defined in the characteristic classification library 202. When the work time distribution includes a characteristic defined in a distribution characteristic 2031, the work time is defined by applying a work time definition algorithm 2032. For example, in a case of the work time distribution with the plurality of mountains (multimodality), and when the local maximum points of the plurality of mountains are larger than the predetermined threshold, a work time dependent element other than the work code is added and defined to define the work time of the work code. Further, when the inclination on the right side of the mountain (inclination of a side where the work time is long) is equal to or less than a predetermined threshold, the work time of the work code is defined in a manner decomposed into a net work time and a wait time. Further, when the peaks are present, the work time of the work code is defined with the peaks are removed as an outlier. Further, when the data loss rate is equal to or larger than a threshold, the work time of the work code is defined with the data loss complement algorithm applied.

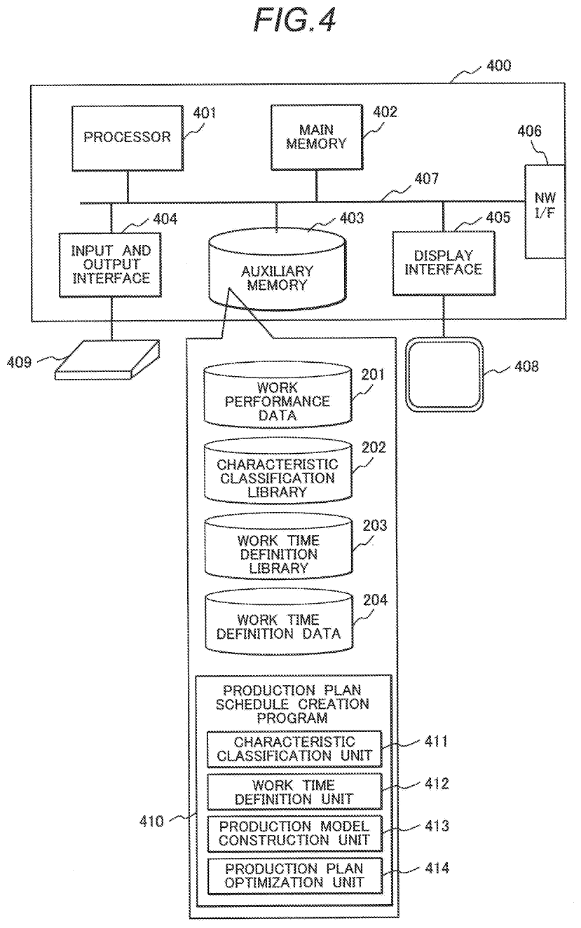

FIG. 4 shows a hardware configuration example of an information processing device that executes the production plan schedule creation flow shown in FIG. 1. An information processing device 400 includes a processor 401, a main memory 402, an auxiliary memory 403, an input and output interface 404, a display interface 405 and a network interface 406, and these members are coupled by a bus 407. The input and output interface 404 is connected to an input device 409 such as a keyboard and a mouse, and the display interface 405 is connected to a display 408 to implement a GUI. The network interface 406 is an interface for connecting to a network. The auxiliary memory 403 is generally configured with a nonvolatile memory such as an HDD, a ROM, or a flash memory, and stores a program to be executed, data to be processed by the program, and the like. The main memory 402 is configured with a RAM, and temporarily stores a program, data required for executing the program, and the like according to an instruction of the processor 401. The processor 401 loads a program from the auxiliary memory 403 to the main memory 402 and executes the program. The information processing device 400 can be implemented by, for example, a personal computer (PC) or a server.

In the auxiliary memory 403, the work performance data 201, the characteristic classification library 202, the work time definition library 203, the work time definition data 204 in which the work time for modeling, which is defined for modeling for each product model number and for each work code, other data, a production plan schedule creation program 410, and other programs are stored. The production plan schedule creation program includes a characteristic classification unit 411, a work time definition unit 412, a production model construction unit 413, and a production plan optimization unit 414 as main parts thereof. The characteristic classification unit 411, the work time definition unit 412, the production model construction unit 413, and the production plan optimization unit 414 execute the characteristic classification step 101, the work time definition step 102, the production model construction step 103, and the production plan optimization unit 104 shown in FIG. 1, respectively. In this way, functions such as calculation and control of the information processing device are implemented by executing the program (software) stored in the auxiliary memory by the processor in cooperation with other hardware in predetermined processing. A program executed by the information processing device, a function thereof, or a method of implementing the function may be referred to as a “function”, a “method”, a “section”, a “unit”, a “module”, and the like, and for convenience, description may be made using these as subjects. Further, In the present embodiment, functions equivalent to functions configured with the software can be implemented by hardware such as a field programmable gate array (FPGA) and an application specific integrated circuit (ASIC). Such embodiments are also within the scope of the invention.

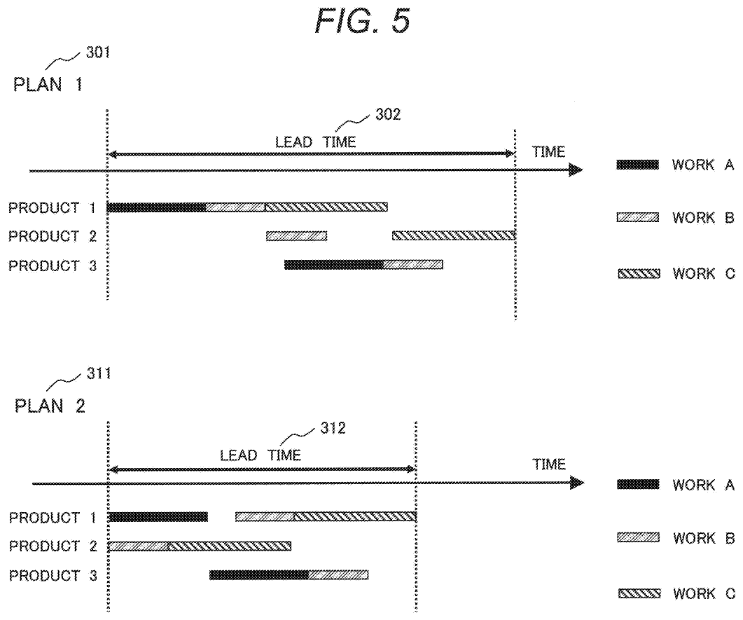

FIG. 5 is an example of a time chart created by production plan scheduling. In both a first plan 301 and a second plan 311, work A to work C are allocated to products 1 to 3 in order to produce the products 1 to 3. Each of products 1 to 3 corresponds to one product model number. In the example, a work time of each of the work A to work C is a fixed value, but a lead time differs depending on how the work A to work C are allocated. There is a constraint condition on the allocation of the work, and the production plan scheduling is to obtain a plan that satisfies the constraint condition and has a shorter lead time to complete production of all of products 1 to 3. A constraint condition in FIG. 5 is that the same work cannot be performed simultaneously on a plurality of products.

In the first plan 301, the work A, the work B, and the work C are allocated to the product 1 without leaving an interval. After the work B of the product 1 is completed, the work B is allocated to the product 2, and after an interval, the work C is allocated to the product 2 after the work C of the product 1 is completed. After the work B of the product 2 is started, the work A of the product 3 is started, and the work B is allocated without leaving an interval. A lead time 302 of the first plan 301 is since the work A of the product 1 is started until the work C of the product 2 is completed.

On the other hand, in the second plan 311, for the product 1, after the work A, an interval is allocated, and the work B and the work C are allocated without leaving an interval. At the same time as the start of the work B of the product 1, the work B is allocated to the product 2, and then the work C is allocated without leaving an interval. After the work A of the product 1, the work A of the product 3 is started, and the work B is allocated without leaving an interval. A lead time 312 of the second plan 311 is from when the work A of the product 1 is started to when the work C of the product 1 is completed.

In the lead time 302 and the lead time 312, the lead time 312 is shorter. Therefore, it can be said that the lead time 312 is a plan with higher productivity than the lead time 302. In the present embodiment, the work time of each work for each product is accurately estimated, so that accuracy of the created plan is improved. Hereinafter, processing of the present embodiment will be described along with a specific example.

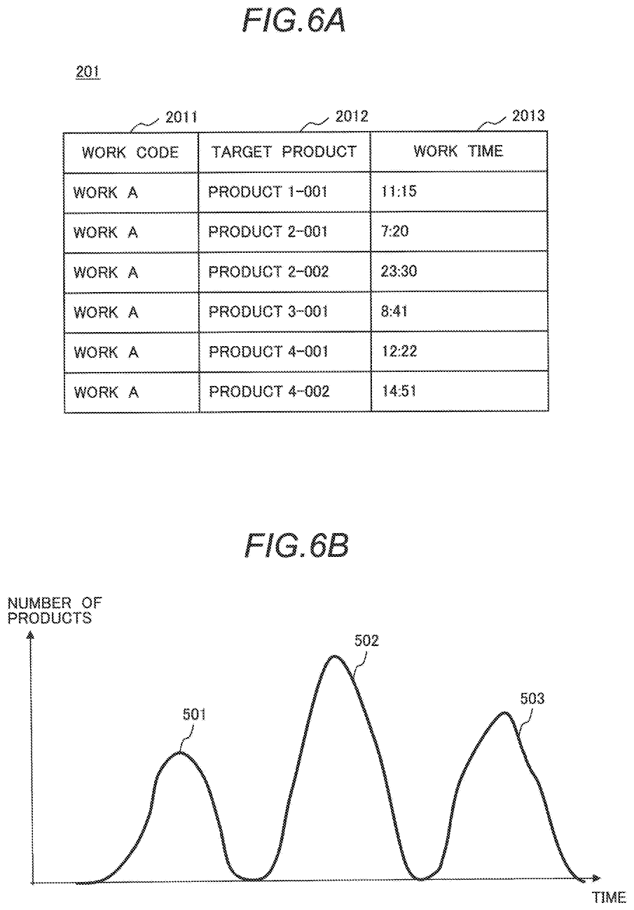

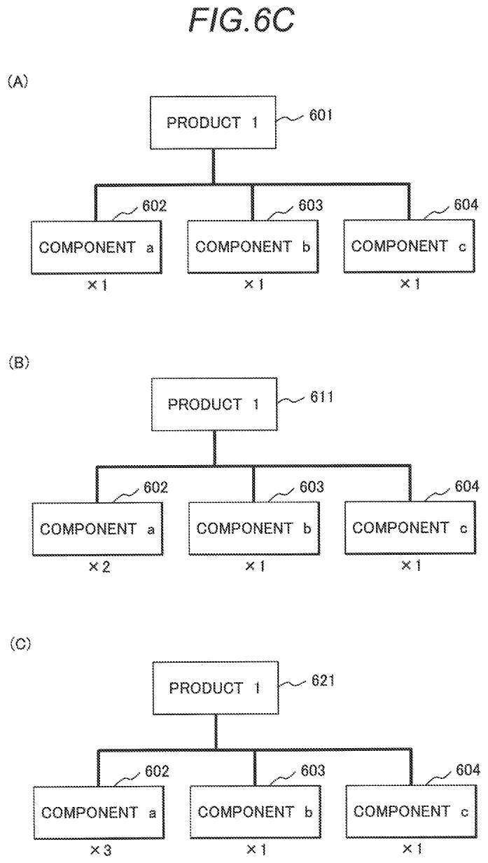

FIG. 6A is an example of the work performance data. A work performance data table 201 includes columns for a work code 2011, a target product 2012, and a work time 2013. In the work code 2011, a work name or a work identification number for uniquely specifying the work is listed. A product name in which the work is performed is listed in the target product 2012. The product is uniquely specified, and in the example in FIG. 6A, the product is recorded in a way in which an identification number for specifying an individual is added to the “product 1” which is the same product model number. The work time 2013 lists a time required to perform the work for the target product. In the example, the time required for the work is recorded, whereas a start time and an end time may be recorded, and a taken time obtained by the start time and the end time may be calculated.

As described with reference to FIG. 5, in the production plan scheduling, it is necessary to define the work time for each product model number and for each work code. FIG. 6B shows an example in which a work time distribution (histogram) is created for a certain work code for a certain product model number (for example, “work A” for “product 1”) based on the work performance data table 201. When the work A is an assembly work, a work time required to assemble the product 1 by the work A is extracted, and a work time distribution (histogram) is created. The work time distribution in FIG. 6B shows multimodality, and three peaks, that is, a first mountain 501, a second mountain 502, and a third mountain 503 are seen.

When the work time distribution has one mountain (when the work time distribution is unimodal), the work time for the work code may be defined as a representative value of the mountain appearing in the work time distribution, for example, a peak value of the mountain or a mode or a median of the work time distribution as a work time for modeling. On the other hand, when the plurality of mountains are present in the work time distribution as shown in FIG. 6B (when the work time distribution is multimodal), when the work time required for the work code is defined as, for example, a representative value of the second mountain 502, it can be expected that large deviation occurs between an actual work time and the defined work time with a considerable probability, which is not suitable as the work time defined for modeling. When the work time distribution shows the multimodality, it is considered that the work time distribution depends on factors other than the work code, and it is necessary to separate into the three mountains according to the factors.

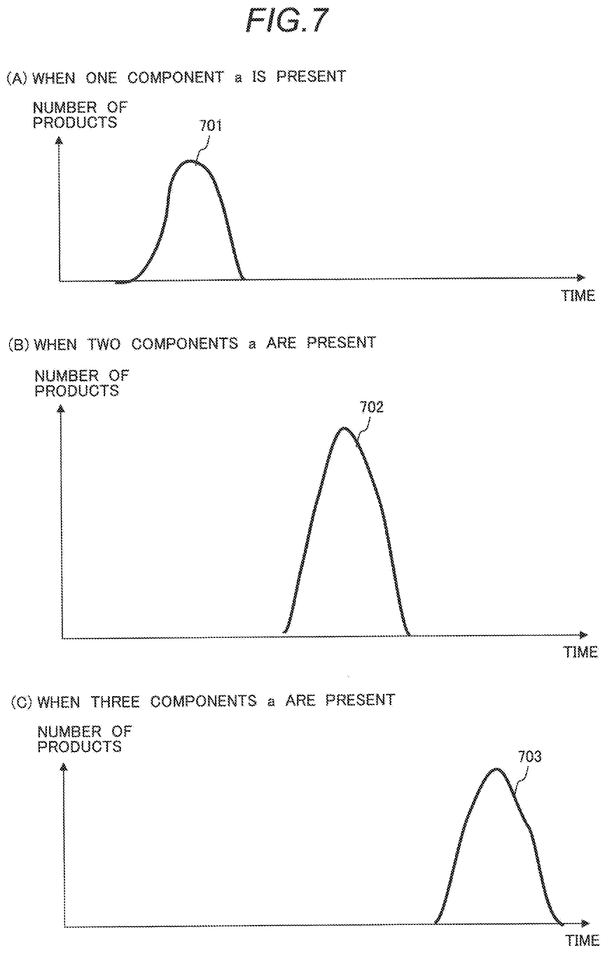

This is because the work code is defined by a workplace, and even if the work is performed on a product having the same product model number with the same work code, there is a difference in an amount of the work and a content of the work. For example, even a product having the same product model number may have different component configurations of the product. FIG. 6C is an example of a component management table (BOM diagram) of the product 1. Although it is shown that the product 1 includes a component a, a component b, and a component c, the number of components may be different even for the same product 1. That is, it is shown that the product 1 (601) is assembled by using one component a, one component b and one component c, the product 1 (611) is assembled by using two components a, one component b and one component c, and the product 1 (621) is assembled by using three components a, one component b and one component c. At this time, a difference in the number of the components a may be reflected in the work time (assembly time). For example, as shown in FIG. 7, the work performance data is classified according to the number of components a of the product 1 and a work time distribution (histogram) is created. A graph 701 is a work time distribution when one component a is present, a graph 702 is a work time distribution when two components a are present, and a graph 703 is a work time distribution when three components a are present. At this time, for the work A, when the work time distributions are classified according to the number of components a, each of the work time distributions is separated into one mountain, and by defining the representative value of the mountain, for example, the peak value of the mountain or the mode or the median of the work time distribution as the work time for modeling for each mountain, the representative value can be defined as a work time with high accuracy.

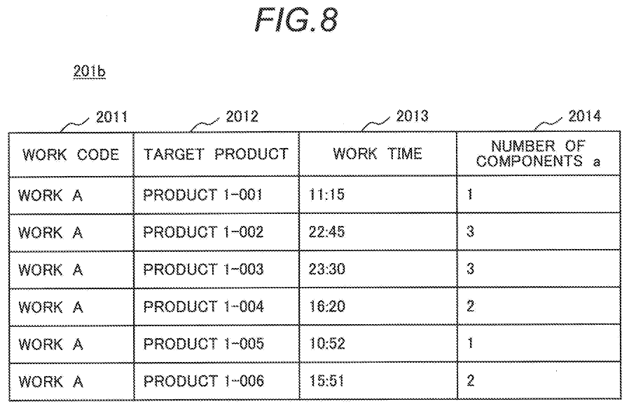

When a factor affecting the work performance data is clarified in this way, a column relating to the factor is added to the work performance data. At this time, as shown in FIG. 8, a column 2014 showing the number of the components a is added. Accordingly, as shown in FIG. 7, the work time distribution is classified by the column 2014, and the work time distribution (histogram) separated for each mountain can be drawn.

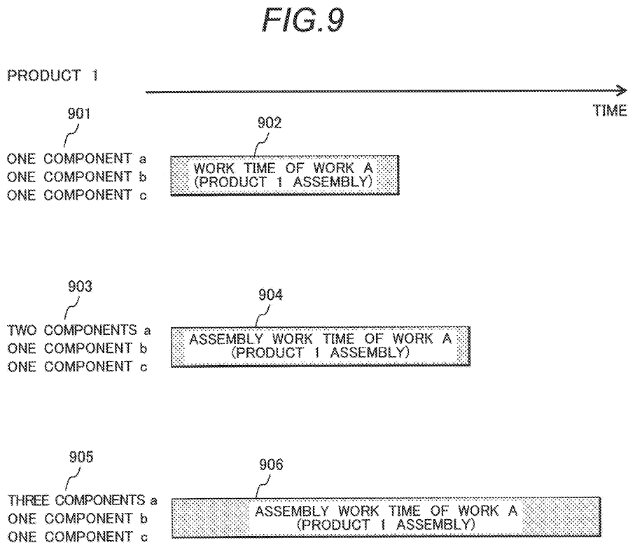

FIG. 9 is a time chart showing the work time defined in a work code A for the product 1. As described above, for the product 1, a different work time is defined for each number of components a, which is a factor affecting the work performance data. A work time defined by the work code A of the product 1 (901) including one component a is a work time 902, a work time defined by the work code A of the product 1 (903) including two components a is a work time 904, and a work time defined by the work code A of the product 1 (905) including three components a is a work time 906, where the work time 902<the work time 904<the work time 906. In this way, by defining the work time of the work code A for the product 1 for each number of components a of the product 1, it is possible to reduce an error between the model and the actual work time than when the work time of the work code A is uniform.

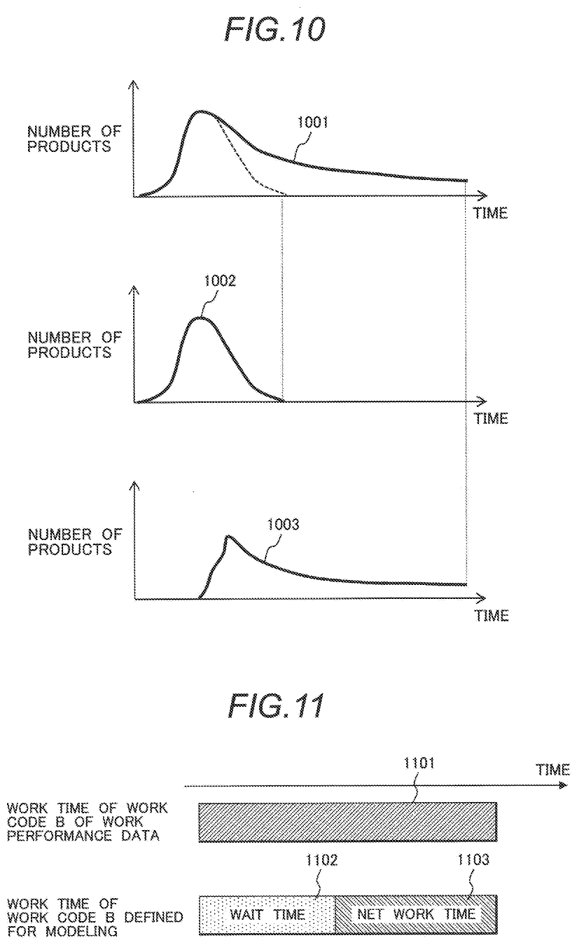

FIG. 10 is, for example, a work time distribution of work performance data of a work code B. In a graph 1001, a left side of a mountain of the graph is a steep creasing curve, while a right side of the mountain is a gentle decreasing curve. In this way, the graph 1001 showing a distribution having a long tail in a long work time direction is considered to be a combination of two distributions having different characteristics. A graph 1002 is a partial graph showing a steep creasing curve on the left side of the graph 1001 and the bilaterally symmetric normal distribution, and a graph 1003 is a distribution obtained by removing the graph 1002 from the graph 1001.

At this time, as shown in FIG. 11, a work time of the work code B is defined in a manner decomposed into a wait time 1102 and a net work time 1103. It is considered that work performance data corresponding to the net work time 1103 has a work time distribution corresponding to the graph 1002. On the other hand, it is considered that work performance data corresponding to the wait time 1102 has a work time distribution corresponding to the graph 1003. Since the time is consumed by a factor unrelated to the actual work, the work time distribution often shows the long tail. For the network time 1103, a representative value of the graph 1002, for example, a peak value of the graph 1002 or a mode or a median of the work time distribution may be defined as the work time for modeling. Further, for the wait time 1102, a representative value of the graph 1003, for example, an average value, a mode, or a median of the work time distribution may be defined as the work time for modeling. In this way, the work time is decomposed for each factor that determines the work time and the work time is defined for each factor, so that the work time with high accuracy can be defined.

Further, in the characteristic classification step, when the peaks are present or when the data loss rate is equal to or larger than the threshold, predetermined preprocessing is performed on the work performance data, and then the work time is defined. Further, when the peaks are present, preprocessing of removing the peaks as the outlier is performed. When the data loss rate is equal to or larger than the threshold, preprocessing of performing data loss complement is performed. When one bilaterally symmetric mountain is present in the preprocessed work time distribution, the representative value of the mountain, for example, the peak value of the mountain or the mode or the median of the work time distribution, is defined as the work time for modeling. On the other hand, when the pre-processed work time distribution shows the multimodality or shows a bilaterally asymmetrical shape, the work time may be defined by applying the work time definition algorithm described above.

### REFERENCE SIGN LIST

101 characteristic classification step
102 work time definition step
103 production model construction step
104 production plan optimization unit
201 work performance data
202 characteristic classification library
203 work time definition library
204 work time definition data
400 information processing device
401 processor
402 main memory
403 auxiliary memory
404 input and output interface
405 display interface
406 network interface
407 bus
408 display
409 input device
410 production plan schedule creation program

1. A production plan schedule creation method for making a production schedule for producing products related to a plurality product model numbers by performing work related to a plurality of work codes for each product, the production plan schedule creation method comprising:
extracting, from work performance data required for work related to a predetermined work code for a product related to a predetermined product model number, a characteristic of a work time distribution for each product model number and for each work code based on a characteristic classification library;
when the extracted characteristic of the work time distribution for each product model number and for each work code includes a distribution characteristic defined in a work time definition library, creating work time definition data that defines a work time for each product model number and for each work code in accordance with an algorithm defined in the work time definition library according to the distribution characteristic;
constructing a production model for producing the products related to the plurality of product model numbers using the work time definition data; and
optimizing the production model to minimize a lead time of the production model.

2. The production plan schedule creation method according to claim 1, wherein
the characteristic classification library includes a program for extracting the number of mountains in the work time distribution as the characteristic of the work time distribution, and
when a plurality of the mountains are present as the characteristic of the work time distribution for each product model number and for each work code, the work time for each product model number and for each work code is defined as a work time including a work time dependent element other than the work code.

3. The production plan schedule creation method according to claim 1, wherein
the characteristic classification library includes a program for extracting a difference between left and right inclinations of a mountain in the work time distribution as the characteristic of the work time distribution, and
when the inclination on a right side of the mountain is equal to or less than a predetermined threshold as the characteristic of the work time distribution for each product model number and for each work code, the work time for each product model number and for each work code is defined in a manner decomposed into a net work time and a wait time.

4. The production plan schedule creation method according to claim 1, wherein
the characteristic classification library includes a program for extracting a peak having no base as a normal distribution in the work time distribution as the characteristic of the work time distribution, and
when a peak is present as the characteristic of the work time distribution for each product model number and for each work code, when the work time for each product model number and for each work code is defined, preprocessing of removing work performance data related to the peak as an outlier is performed.

5. The production plan schedule creation method according to claim 1, wherein
the characteristic classification library includes a program for calculating a data loss rate of the work performance data for each product model number and for each work code, and
when the data loss rate of the work performance data for each product model number and for each work code is equal to or larger than a predetermined threshold, a data loss complement algorithm is applied as preprocessing for the work performance data for each product model number and for each work code.

6. An information processing device configured to make a production schedule for producing products related to a plurality product model numbers by performing work related to a plurality of work codes for each product, the information processing device comprising:
a processor;
a memory; and
a production plan schedule creation program read into the memory and to be executed by the processor, wherein
the production plan schedule creation program includes a characteristic classification unit, a work time definition unit, a production model construction unit, and a production plan optimization unit,
the characteristic classification unit is configured to extract, from work performance data required for work related to a predetermined work code for a product related to a predetermined product model number, a characteristic of a work time distribution for each product model number and for each work code based on a characteristic classification library,
the work time definition unit is configured to, when the characteristic of the work time distribution extracted by the characteristic classification unit for each product model number and each work code includes a distribution characteristic defined in a work time definition library, create work time definition data that defines a work time for each product model number and for each work code in accordance with an algorithm defined in the work time definition library according to the distribution characteristic,
the production model construction unit is configured to construct a production model for producing the products related to the plurality of product model numbers using the work time definition data, and
the production plan optimization unit is configured to optimize the production model to minimize a lead time of the production model.

7. The information processing device according to claim 6, wherein
the characteristic classification library includes a program for extracting the number of mountains in the work time distribution as the characteristic of the work time distribution, and
the work time definition unit is configured to, when a plurality of the mountains are present as the characteristic of the work time distribution for each product model number and for each work code, define the work time for each product model number and for each work code as a work time including a work time dependent element other than the work code.

8. The information processing device according to claim 6, wherein
the characteristic classification library includes a program for extracting a difference between left and right inclinations of a mountain in the work time distribution as the characteristic of the work time distribution, and
the work time definition unit is configured to, when the inclination on a right side of the mountain is equal to or less than a predetermined threshold as the characteristic of the work time distribution for each product model number and for each work code, define the work time for each product model number and for each work code in a manner such that the work time is decomposed into a net work time and a wait time.

9. The information processing device according to claim 6, wherein
the characteristic classification library includes a program for extracting a peak having no base as a normal distribution in the work time distribution as the characteristic of the work time distribution, and
the work time definition unit is configured to, when a peak is present as the characteristic of the work time distribution for each product model number and for each work code, when defining the work time for each product model number and for each work code, perform preprocessing of removing work performance data related to the peak as an outlier.

10. The information processing device according to claim 6, wherein
the characteristic classification library includes a program for calculating a data loss rate of work performance data for each product model number and for each work code, and
the work time definition unit is configured to, when the data loss rate of the work performance data for each product model number and for each work code is equal to or larger than a predetermined threshold, apply a data loss complement algorithm as preprocessing for the work performance data for each product model number and for each work code.
